(19) United States
(12) Patent Application Publication
(10) Pub. No.: US 2002/0170930 A1
(43) Pub. Date: Nov. 21, 2002

(54) Fluid dispensing closure and method of manufacturing same

(76) Inventor: Jack E. Elder, Rochester, MI (US)

Correspondence Address: Harold C. Moore, Maginot, Moore & Bowman, Bank One Center/Tower, 111 Monument Circle, Suite 3000, Indianapolis, IN, 46204-5115, US

(21) Appl. No.: 10/133,235

(22) Filed: Apr. 26, 2002

Related U.S. Application Data
(60) Provisional application No. 60/287,520, filed on Apr. 26, 2001.

(51) Int. Cl. B67D 3/00

(52) U.S. Cl. 222/534

(57) ABSTRACT

A spout assembly for use with a container having an internal chamber in communication with a predefined opening that is sealed with a frangible sealing material includes a base member, a hollow body, and a puncture member. The base member is configured to be secured to the container, and is further configured to cover the predefined opening. The hollow body defines a passage therethrough and is rotatably mounted to the base member to be movable between an open position and a closed position. The puncture member is formed with the hollow body, the puncture member configured to puncture the sealing member when the hollow body is moved from the closed position to the open position.

This application claims the benefit of U.S. Provisional Patent Application Serial No. 60/287,520, filed Apr. 26, 2001, and which is incorporated herein by reference.

### FIELD OF THE INVENTION

The present invention relates generally to the field of closures, and more particularly to fluid dispensing closures and containers for use therewith.

### BACKGROUND OF THE INVENTION

Liquids are provided in a variety of containers having a variety of openings or spouts. By way of example, aluminum cans and other metal containers employ a press or pull tab that creates an opening in the top surface of the container. Alternatively, many paper containers, such as milk cartons, include a folded, glued top structure that may be unfolded to create an opening through which the liquid may be dispensed. Plastic and glass containers also often employ rotatable caps, or other versions of caps, that may cover an opening through which the liquid may be dispensed.

Certain types of liquid containers, however, are not readily amenable to the above types of closures. By way of example, drink boxes, often called bricks, are a widely used disposable liquid container that requires a different type of opening. Such drink boxes have gained wide acceptance world-wide because of their convenient shape and because they employ sealing that holds liquids for long periods of time without spoilage. Drink boxes are also relatively simple and inexpensive to construct.

Currently, drink boxes use a number of different dispensing devices, including straws and door closures. Straws typically take the form of short plastic straws, wrapped in a plastic film, that are attached to the sides of drink boxes. For use, they are detached from the box and inserted through a small hole, piercing a foil membrane. One drawback associated with the use of straws is that the container or drink box is not generally re-sealable. Moreover, straws may cause spillage when inserted into the drink box. Moreover, the loose packaging waste due to the cellophane wrapper on the straw and the straw itself are contributors to litter.

Door closures are molded pieces that snap over themselves to provide a closure that includes a door and frame. The closure is glued to the drink containers after filling. These closures are in theory re-sealable, but often leak.

There exists a need for a drink closure that is resealable and which may be used on a drink box or other container while avoiding one or more, and preferably many, of the drawbacks of the prior art.

### SUMMARY OF THE INVENTION

The present invention addresses the above described need, as well as others, by providing a drink closure assembly that includes a hollow body having an internal passage defined therethrough. The hollow body is rotatably mounted on the container to move between a closed position and an open position. The hollow body functions as a straw or pour spout. The hollow body further preferably includes a puncture member for piercing a sealing member on a container when the hollow body is opened. Such sealing members are typically employed on drink boxes to effect the oxygen barrier. Thus, the present invention provides an easy to use, resealable device that may be used in disposable drink containers that employ sealing members.

Optionally, the hollow body and the container may employ detents to retain the hollow body in either the open or the closed position. In another option, the hollow body may rest in a protective cavity that inhibits inadvertent opening.

One embodiment of the invention is a spout assembly for use with a container having an internal chamber in communication with a predefined opening that is sealed with a frangible sealing material. The spout assembly includes a base member, a hollow body, and a puncture member. The base member is configured to be secured to the container, and is further configured to cover the predefined opening. The hollow body defines a passage therethrough and is rotatably mounted to the base member to be movable between an open position and a closed position. The puncture member is formed with the hollow body, the puncture member configured to puncture the sealing member when the hollow body is moved from the closed position to the open position.

Another embodiment of the present invention is another spout assembly for use with a container having an internal chamber in communication with a predefined opening. This spout assembly includes a base member and a hollow body. The base member is configured to be secured to the container. The hollow body defines a passage therethrough and is rotatably mounted to the base member to be movable between a non-closed position and a closed position, the passage and the predefined opening in the chamber being in communication in the non-closed position. At least one of the hollow body or base member includes a first detent for engaging a first feature in the other of the hollow body or base member when the hollow body is in the closed position. Furthermore, at least one of the hollow body or base member includes a second detent for engaging a second feature in the other of the hollow body or base member when the hollow body is the non-closed position.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective view of an exemplary embodiment of a container assembly according to the present invention, wherein the hollow body is in the closed position;

FIG. 2 shows a partially exploded perspective view of the container assembly of FIG. 1 wherein the hollow body is in a non-closed position;

FIG. 3 shows a side plan view of the spout assembly of the container assembly of FIG. 1;

FIG. 4 shows a front plan view of the spout assembly of the container assembly of FIG. 1;

FIG. 5 shows a cutaway view of the spout assembly of FIG. 3 taken along line V-V of FIG. 3;

FIG. 6 shows a cutaway view of the spout assembly of FIG. 3 taken along line VI-VI of FIG. 10;

FIG. 7 shows the cutaway view of the spout assembly of FIG. 6 wherein the hollow body is in the non-closed position;

FIG. 8 shows an enlarged, fragmentary detail of a portion of FIG. 6;

FIG. 9 shows a cutaway view of the spout assembly of FIG. 3 taken along line IX-IX of FIG. 10;

FIG. 10 shows a top plan view of the spout assembly of FIG. 3;

FIG. 11 shows a top perspective view of a second exemplary embodiment of a spout assembly according to the present invention wherein the hollow body is in the non-closed position;

FIG. 12 shows a bottom perspective view of the spout assembly of FIG. 11;

FIG. 13 shows a side cutaway view of the spout assembly of FIG. 11 taken along line XIII-XIII of FIG. 11;

FIG. 14 shows a rear plan view of another embodiment of a spout assembly according to the present invention wherein the hollow body is in the non-closed position;

FIG. 15 shows a side plan view of the spout assembly of FIG. 14;

FIG. 16 shows a front plan view of the spout assembly of FIG. 14;

FIG. 17 shows a front perspective view of the spout assembly of FIG. 14;

FIG. 18 shows a rear perspective view of the spout assembly of FIG. 14;

FIG. 19 shows a front perspective view of the spout assembly of FIG. 14 wherein the hollow body is in the closed position; and

FIG. 20 shows a top plan view of the spout assembly of FIG. 14.

### DETAILED DESCRIPTION

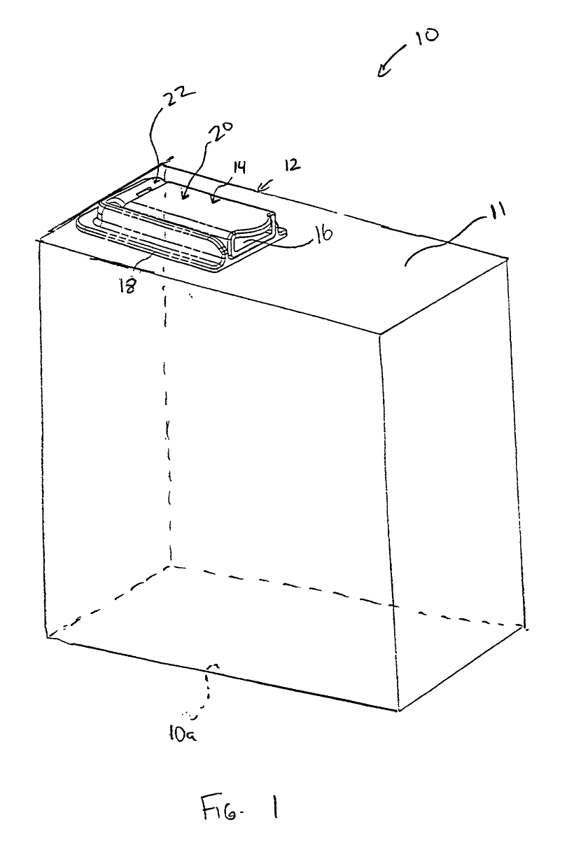

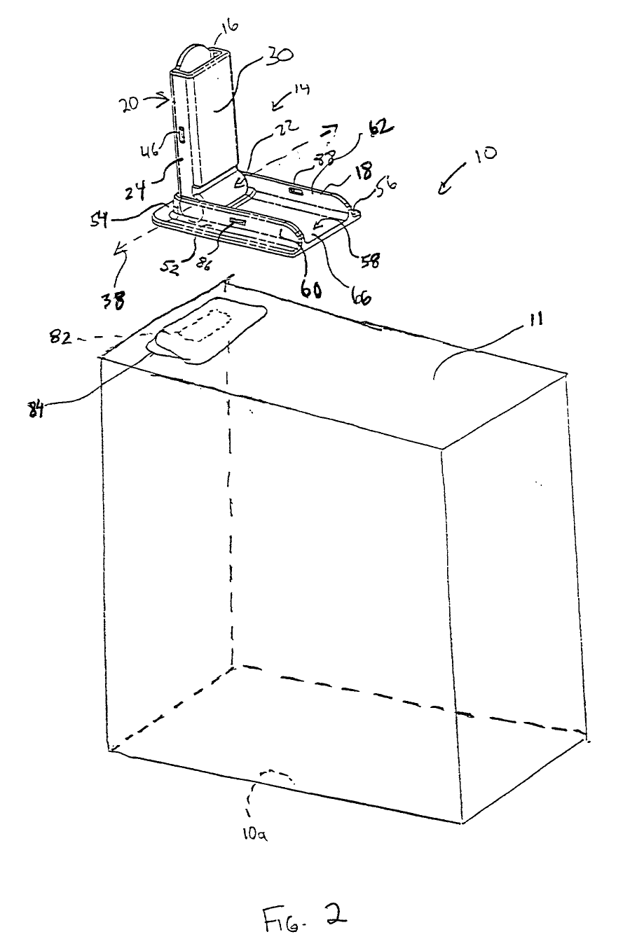

FIGS. 1 and 2 show an exemplary embodiment of a container assembly 10 according to the present invention. FIGS. 3 through 10 illustrate various views of elements of the container assembly 10.

Referring generally to FIGS. 1 through 10, the container assembly 10 includes a container 12 and a rotatably mounted hollow body 14. The hollow body 14 defines a passage 16 therethrough. In the embodiment disclosed herein, the container 12 further contains a base member 18 to which the hollow body 14 is rotatably mounted. In alternative embodiments that hollow body 14 may be rotatably mounted to another type of member on the container, or to the top surface or another surface of this or another form of container.

Referring again to the embodiment of FIGS. 1 through 10, the hollow body 14 is movable from a closed position (see FIG. 1) to a non-closed position (see FIG. 2). As will be discussed further below, fluid may flow from an internal chamber of the container 12 through a passage 16.

Referring generally to FIGS. 1 through 10, the hollow body 14 generally comprises an elongate generally rectangular body 20 terminating in a hinge member 22. The rectangular body 20 includes two side walls 24, 26, a top wall 28, and a bottom wall 30. The top wall 28 defines a top surface of the rectangular body 20 and extends from an upper portion 32 of the hinge member 22 to an exit end 36 of the passage 16 its other end. The bottom wall 30 defines a bottom surface of the rectangular body 20 and extends from a bottom portion 34 of the hinge member 24 to the exit end 36 of the passage 16 at its other end.

At least a portion of the top wall 28 preferably extends further away from the hinge member 22 than the bottom wall 30 in order to define an overhang 38. The overhang 38 serves to provide a finger grip for assisting in lifting the hollow body 14 from the closed position to the open position, particularly if the hollow body is at least partially received into a cavity that inhibits access to the side walls 24, 26. To this end, it will be appreciated that the overhang 38 may take a plurality of shapes, so long as it at least partially extends further than the bottom wall 30.

The top portion 32 and the bottom portion 34 both have an outer arcuate surface. As a result, the top portion 32 and the bottom portion 34 combine to form a generally cylindrical shape for the hinge member 22 to facilitate rotation of the hollow body 14 about a defined axis 38. The hinge member 22 further includes a puncture member 40 formed therewith. The puncture member 40 in this embodiment extends outward from the bottom portion 34 and includes an acute edge 42 and its end. The top portion 32 of the hinge member 22 includes a depression 44 defined therein. The depression 44 forms a concavity in approximately the radial direction (i.e., generally inward toward the axis 38). As will be discussed below, the depression 44 is configured to receive a protrusion (i.e. detent) 90 in the base member 18 in order to retain the hollow body 14 in a non-closed position.

The hinge member 22 further includes first and second trunnions 70 and 72 about which the hinge member 22 pivots between the closed and non-closed positions.

Referring again to the rectangular body 20, each of the side walls 24, 26 includes a corresponding detent 46, 48 extending axially (i.e. in the same general direction as the axis 38) therefrom. As will be discussed below, the detents 46, 48 cooperatively engage features 86, 88 on the base member 18 in order to retain the hollow body 14 in a closed position.

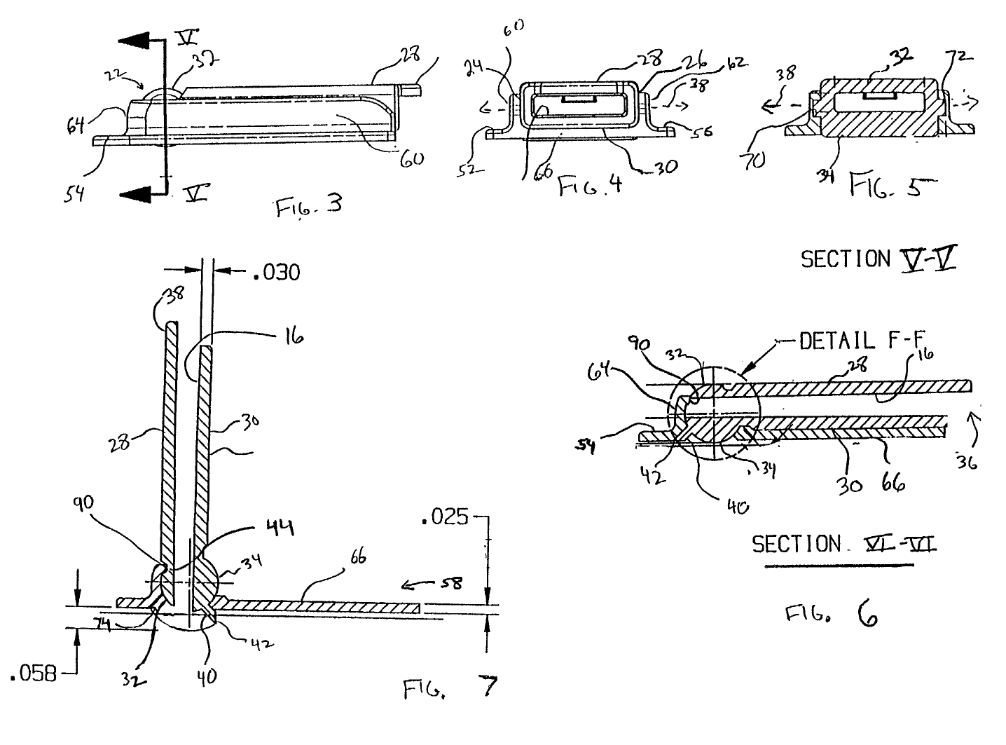

The base member 18 includes an enclosure structure 50 formed with one or more edge surfaces 52, 54 and 56. The enclosure structure 50 is configured to define a cavity 58 in which the hollow body 14 is received. To this end, the enclosure structure 50 includes two side members 60, 62, a back member 64, and a bottom member 66. The bottom member 66 and the edge surfaces 52, 54 and 56 define a bottom surface of the base member 18. The bottom member 66 includes an aperture 74 defined therein. The aperture 74 is disposed in a position in which it aligns with the passage 16 of the hollow body 14 when the hollow body 14 is in one or more non-closed positions, such as is shown in FIG. 2 and 7. The aperture 74 and bottom member 66 are further configured such that the bottom portion 34 of the hinge member 22 covers the aperture 74 to inhibit liquid flow when the hollow body 14 is in the closed position, such as is shown, for example, in FIG. 6

The side members 60, 62 extend upward generally proximate to the side walls 24, 26 of the hollow body 14. The side members 60, 62 are thus configured to inhibit inadvertent movement of the hollow body 14 in the closed position by reducing access to the hollow body 14. Without the side members 60, 62, the hollow body 14 is more likely to be snagged or accidentally bumped to a non-closed position, thereby potentially resulting in spillage. In the embodiment of FIGS. 1 through 10, the side members 60, 62 extend only partially up the side walls 24, 26. While this provides excellent protection against inadvertent movement of the hollow body 14 from the closed position, it may be preferable in other embodiments to extend the side members 60, 62 even further upward to the top surface of the top wall 28 of the hollow body 14 to increase such protection.

In any event, in the embodiment described herein, the side members 60, 62 include bores 78, 80 configured to rotatably receive the trunnions 70, 72, respectively, of the hollow body 14. The trunnions 70, 72 and the bores 78, 80 cooperate to facilitate the rotating movement between the hollow body 14 and the base 18.

The side members 60, 62 further include features 86, 88 for configured to engage the detents 46, 48 of the hollow body 14 when the hollow body 14 is in the closed position. In the exemplary embodiment described herein, the features 86, 88 consist of cavities or depressions on the insides of the side members 60, 62 that receive the detents 46, 48 when the hollow body 14 is in the closed position. In another embodiment, the features 86, 88 may simply be other detents or protrusions. Regardless of the form of the features 86, 88, the detents 46, 48 and the features 86, 88 cooperate to resist movement out of the closed position. To this end, in the exemplary embodiment described herein, the detents 46, 48 extend slightly beyond the inside surface of the side members 60, 62, such that at least some plastic deformation is required to move the detents 46, 48 (and hence the hollow body 14) past the side members 60, 62. However, when the detents 46, 48 are aligned with the features 86, 88, the plastic deformation releases because there is increased room to accommodate the detents 46, 48. Thus, the detents 46, 48 and the features 86, 88 allow the hollow body 14 to “snap” into the closed position. Because the detents 46, 48 are relatively small and the material is preferably relatively deformable, intentional movement of the hollow body 14 out of the closed position is not difficult. Nevertheless, the resistance to movement effectively inhibits unintentional movement.

The back member 64 extends generally upward in an arcuate manner having an inner radius substantially identical to the outer radius defined by the upper portion 32 and lower portion 34 of the hinge member 22. In general, the back member 64 tightly fits with the upper portion 32 and/or lower portion 34, depending on the position of the hollow body 14, to inhibit liquid flow between any part of the hinge member 22 and the back member 64. Extending generally radially inward from the back member 64 is a protrusion or detent 90 that is configured to engage the depression 44 of the hinge member 22 when the hollow body 14 is in a non-closed position. The detent 90 is configured to extend to a point inward of the outer radius defined by the upper portion 32 and lower portion 34 of the hinge member 22. Accordingly, when the detent 90 is not aligned with the depression 44, the detent 90 is flexed away by the upper portion 32. When the detent 90 becomes aligned with the depression 44 (when the hollow body 14 is in a non-closed position), the detent 90 releases into the depression 44. As a result, the detent 90 and depression 44 tend to retain the hollow body 14 at a particular non-closed position.

The container 10 is shown as a rectangular enclosure, but may take other shapes. The container 10 in any event includes at least one surface 11 in which an opening 82 is defined. The opening is covered by a frangible sealing member 84. The frangible sealing member 84 may suitably be constructed of foil or the like, secured via an adhesive. Currently available drink boxes include similar frangible sealing members through which plastic straws may be inserted.

The base member 16 is coupled to the surface 11 of the container 10, typically via an adhesive, and preferably a heat sensitive adhesive. The base member 16 is arranged on the surface 11 such that the aperture 74 is aligned generally with the opening 82, and that rotation of the hollow body 14 to a non-closed position will cause the puncture member 40 to pass through and rupture the sealing member 84 in the vicinity of the opening 82.

Prior to first use, the sealing member 84 preferably provides an air-tight seal to help preserve the contents in the internal chamber 10a. In the closed position, the detents 46, 48 and the features 86, 88 cooperate to inhibit accidental opening of the container. Moreover, disposition of the hollow body 14 within the cavity 58 defined by the base member 18 helps inhibit inadvertent opening by reducing the amount of surface area of the hollow body 14 that may be accessed.

When the container 10 is first used, the user lifts the hollow body 14 (using the overhang 38) and rotates it upward. As the hollow body 14 rotates upward, the acute edge 42 of the puncture member 40 punctures the sealing member 84 in the position of the opening 82. The hollow body 14 after the rotation upward may be in any of a plurality of non-closed positions. Typically, however, the user rotates the hollow body 14 upward until the detent 90 releases into the depression 44 of the hinge member 22. The release of the detent 90 provides tactile feedback to the user to stop rotating, and moreover tends to hold the hollow body 14 in the associated non-closed position. In many non-closed positions, the internal chamber 10a of the container 10 is in fluid communication with the exit end 36 through the alignment of the opening 82 with the aperture 74. Liquid may then flow through the opening 82, the aperture 74, the passage 16 and out of the exit end 36.

If the user uses some, but not all, of the liquid contents, then user may place the hollow body 14 back to the closed position. To this end, the user rotates the hollow member 14 downward to the closed position. If the detent 90 of the back member 64 was engaged with the depression 44 of the hinge member 22, then the user must apply sufficient force to cause enough elastic deformation to allow the upper portion 32 of the hinge member to traverse the detent 90. In the closed position, liquid flow is inhibited. Specifically, although the sealing member 84 has been compromised, the hollow body 14 in the closed position inhibits liquid flow because the bottom portion 34 of the hinge member 22 effectively closes off the aperture 74. (See FIG. 6).

The above described design features low cost because of its simplicity of design and because the spout assembly itself may be readily molded. The device is scalable for various sizes of liquid packaging.

One molding technique that may be used to make the spout assembly (base member 18 and hollow body 14) involves an in-mold assembly technique. In in-mold assembly, two moving parts are assembled by the molding process. In general, one part is molded, and then that part is used as a portion of the mold for the second part. If materials are properly chosen, then the first part and the second part do not bond, but rather merely fit tightly together as separate pieces. Using this concept, the first and second part may be molded to be movable with respect to each other. Examples of such molding techniques are taught, by way of example, in U.S. Pat. No. 6,261,499, which is incorporated herein by reference.

Applying the in-mold assembly process to the base member 18 and hollow body 14 of FIGS. 1 through 10, the hollow body 14 is produced first, preferably from a polymer or composite. The mold design is dictated by the shape of the hollow body 14 and would be apparent to one of ordinary skill in the art. The base member 18, constructed of a second material (i.e. one that has a different glass transition point), is molded to cover the outside of the hollow body 14 constructed from the first material. The mold design for the second material is dictated as the negative of outer dimensions of the base member 18, with the inner portion of the mold formed by the hollow body 14 of the first material. A portion of the hollow body 14 is kept free from the second material in order to form the fluid passage 16.

As is known in the art, the proper selection of materials is important in order to insure durability and reliability for any liquid valve. The materials must have very low surface abrasion properties and must also have a low coefficient of friction with each other. Various additives may be added to the base polymers to decrease friction between the two parts. As with typical in-mold assembly operations, the shrinkage rates of both materials must be selected to correspond to the desired post-mold retained stress in the joint. Melt temperatures, glass transition temperatures and material additives are important for the materials as it is essential that the second material molded does not erode the structure, geometry or surface finish of the first material. Given these considerations, those of ordinary skill in the molding art may readily select the appropriate materials from various available materials.

When the base member 18 is molded over the hollow body 14 it tends to shrink over the hollow body 14 using it as an armature. The hollow body 14 prevents the base member 18 from totally reaching the shrinkage equilibrium point, thereby causing retained stress in the joint. Although this retained stress will decrease with time it will never decline to null. This retained stress caused by the relative shrinkage of the materials ensures a tight, leak tight, “shrink-wrapped” relationship between the hinge member 22 and the members 64 and 66. A valve designed as such requires no additional elastomeric or other type of seals.

The spout assembly (base member 18 and hollow body 14) can be molded in either the closed position or non-closed position. The preferred embodiment is to mold the spout assembly in the closed position.

It is noted that several advantages of the above described embodiment may be obtained regardless of whether in-mold assembly is used to form the spout assembly. Moreover, at least some of the advantages of the use of a spout assembly having one or more of the detent aspects described above may be obtained even in spout assemblies that lack other elements, such as the gripping overhang or the use of side walls to inhibit inadvertent movement of the hollow body 14. Likewise, at least some of the advantages of using such side walls may be obtained even without using detents. Finally, some or all of the mechanical advantages of the above described spout assembly, while particularly useful in a drink box-type environment, may be obtained in other environments.

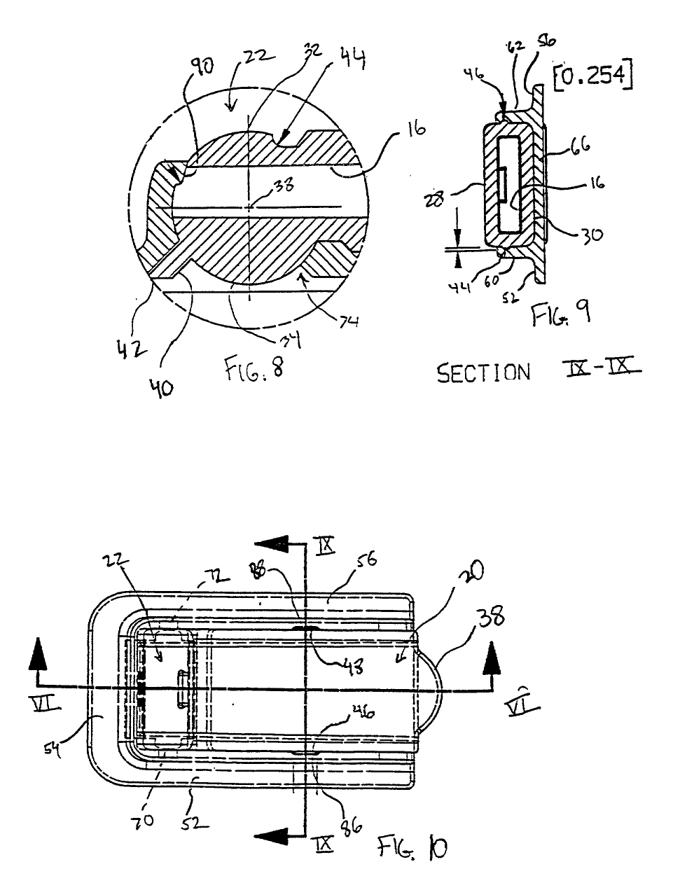

The embodiment shown in FIGS. 11 through 13 has similar features, but is suited to other environments in which the base forms the top surface of the container. As shown in FIGS. 11 through 13 the spout assembly 110 includes a hollow body 114 forming a passage 112 therethrough. The hollow body 114 is rotatably mounted to a base member 116 and is capable of moving between a closed position and a non-closed position. The hollow body 114 has a different shape than the hollow body 14 of FIGS. 1 through 10, but has many similar features.

Referring generally to FIGS. 11 through 13, the hollow body 114 generally comprises an elongate generally rectangular body 120 terminating in a hinge member 122. The rectangular body 120 includes a top wall 128 and a bottom wall 130. The top wall 128 defines a top surface of the rectangular body 120 and extends from an upper portion of the hinge member 122 to an exit end 136 of the passage 112 its other end. The bottom wall 130 defines a bottom surface of the rectangular body 120 and extends from a bottom portion of the hinge member 122 to the exit end 136 of the passage 112 at its other end. At least a portion of the top wall 128 preferably extends further away from the hinge member 122 than the bottom wall 130 in order to define an overhang 138.

The overhang 138, similar to the overhang 38 of the embodiment of FIGS. 1 through 10, serves to provide a finger grip for assisting in lifting the hollow body 114 from the closed position to the open position.

The hinge member 122 is configured to facilitate rotation of the hollow body 114 about a defined axis. To this end, the hinge member 122 further includes first and second trunnions, not visible in FIGS. 11 through 13, but which are similar in form and function as the trunnions 70 and 72, about which the hinge member 122 pivots between the closed position (e.g. FIG. 6) and the non-closed position (e.g. FIG. 7). The hinge member 122 further includes an opening 123, which represents one end of the passage 112, through which liquid may pass when the hollow body 114 is in the non-closed position.

The base member 116 includes a container top plate 150, an annular ridge 152 on the bottom side of the top plate 150, and a cavity 158. The cavity 158 is configured to receive the hollow body 114. To this end, the cavity 158 is formed by two side members 160, 162, a back member 164, a front member 165, and a bottom member 166. The bottom member 166 includes an aperture 174 defined therein. The aperture 174 is disposed in a position in which it aligns with the opening 123 of the hollow body 114 when the hollow body 114 is in one or more non-closed positions, such as is shown in FIGS. 11 through 13. The aperture 174, bottom member 166, and the hinge member 122 are further configured such that the bottom portion of the hinge member 122 covers the aperture 174 to inhibit liquid flow when the hollow body 114 is in the closed position.

The bottom member 166 further includes a vent 180 which assists in liquid flow by allow replacement air to flow in as liquid flows out through the passage 112. The bottom wall 130 of the hollow body 114 may suitably include a plug 181 to close off the spout 180 when the hollow body 114 is in the closed position. An additional spout 182 may be provided on the top plate 150.

The side members 160, 162 extend upward generally proximate to corresponding side walls (e.g. side wall 124) of the hollow body 114. The side members 160, 162 are thus configured to inhibit inadvertent movement of the hollow body 114 in the closed position by reducing access to the hollow body 114. In the embodiment of FIGS. 11 through 13, the side members 160, 162 extend completely up to the level of the top surface of the top wall 128 of the hollow body 114.

In any event, in the embodiment described herein, the side members 160, 162 include bores, not shown, configured to rotatably receive the trunnions of the hollow body 114. The trunnions and the bores cooperate to facilitate the rotating movement between the hollow body 114 and the base 116.

The back member 164 extends generally upward, preferably, but not necessarily, in an arcuate manner. In any event, the back member 164 is configured to engage throughout its side-to-side dimension the outer radius of the hinge member 122.

The top plate 150 and the annular ridge 152 are configured to a shape and size that corresponds to the shape and size of the opening in the container, not shown. While the shape in the exemplary embodiment described herein is circular, it will be appreciated that the shape of the top plate 150 may readily be designed in any shape, including but not limited to ellipsoid, square, rectangular, and other polygonal or curved shapes.

Adhesive may be applied to the annular ridge 152 and/or the portion of the underside of the top plate 150 that is radially outward of the annular ridge 152 to secure the spout assembly 110 to the container.

The above embodiment shows, among other things, how a hollow body according to the present invention may be attached to a base member that is part of the container itself. It will also be appreciated that such embodiment may readily be adapted to incorporate detents to hold the hollow body in the closed and/or non-closed position, and furthermore to include a puncture member, such as are present in the embodiment of FIGS. 1 through 10.

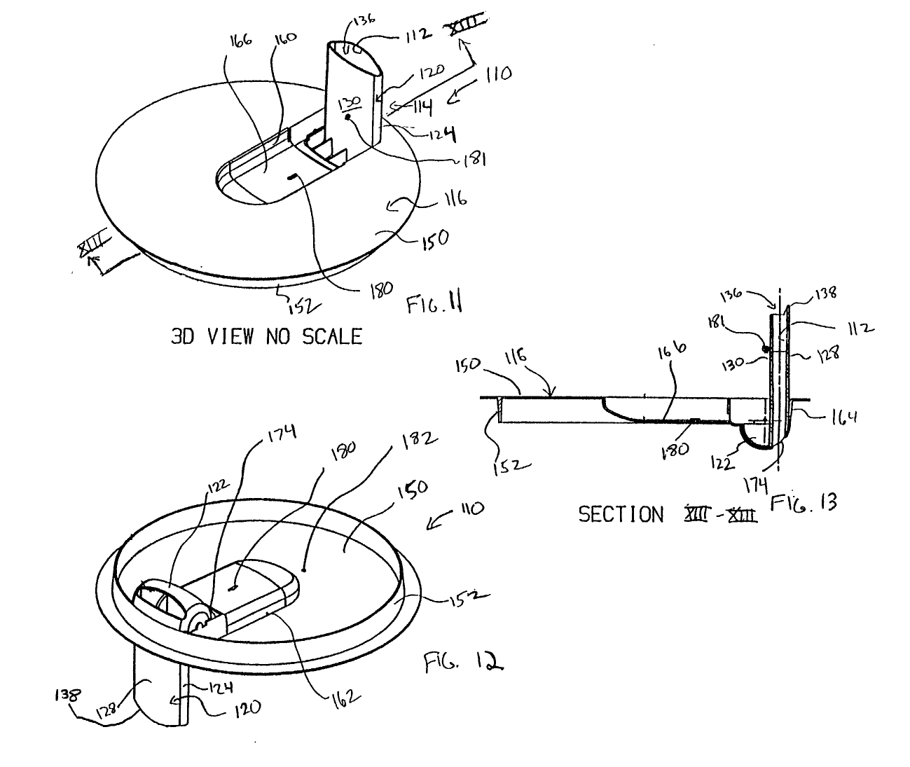

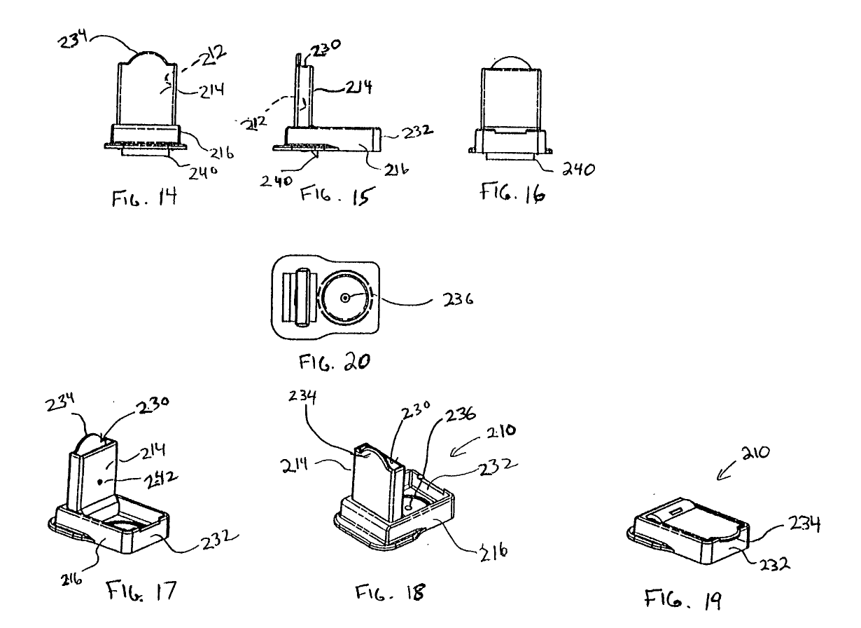

Another embodiment of a spout assembly according to the present invention is shown in FIGS. 14 through 20. The closure 210 includes a hollow body 214 and a base member 216. The hollow body 214 is similar to the hollow body 14 of FIGS. 1 through 10. To this end, the hollow body 214 includes a rectangular body, hinge member, and puncture member 240 similar to the corresponding devices in the hollow body 14.

In this embodiment, the exit end 230 of the hollow body 214 is hidden by a wall 232 extending up from a bottom surface of the base member 216. The wall 232 seals the exit end 230 of the spout, in the closed position, (FIG. 19), making the interior flow passage 212 more secure and less likely to pick up contaminants. When in the closed position, the overhang 234 located on the hollow body 214 projects beyond the wall 232 which allows the end user to grab and rotate the hollow body 214 into an open position with a finger.

Preferably, the bottom surface of the base member 216 includes a vent hole 236 to allow make-up air to enter the dispensing container when the hollow body 214 is in the non-closed position. When the hollow body 214 is in the closed position, the vent hole 236 is closed and sealed by the hollow body 214. To this end, the hollow body 214 may include a projection 242 that seals off the vent hole 236.

In general, the spout assembly 210 may be fastened to the drink container, not shown, using a heat sensitive adhesive. After assembly, as the hollow body 214 is actuated into the open position, the puncture member 240 sweeps downwards, breaking the plane of a sealing member on the container. The puncture member 240 also gathers this oxygen barrier and holds it out of the flow passage, while the hollow body 214 is in the open position.

Accordingly, this aspect of the invention provides a cost-effective method of dispensing or valving fluids in throw-away packaging.

The economic advantages of producing this design may be enhanced using the “in-mold assembly” techniques described above, where finished parts exit the molding machine on every cycle. Costly labor and automated assembly machines are not needed. Quality is improved because of the reduction in variation caused by the tolerance stackups inherent in conventionally manufactured components.

It will be appreciated that the above described embodiments are merely illustrative, and that those of ordinary skill in the art may readily devise their own implementations that incorporate the principles of the present invention and fall within the spirit and scope thereof.

We claim:

1. A spout assembly for use with a container having an internal chamber in communication with a predefined opening that is sealed with a frangible sealing material, the spout assembly comprising:
a base member configured to be secured to the container, the base member configured to cover the predefined opening;
a hollow body defining a passage therethrough, the hollow body rotatably mounted to the base member to be movable between an open position and a closed position;
a puncture member formed with said hollow body, the puncture member configured to puncture the sealing member when the hollow body is moved from the closed position to the open position.

2. The spout assembly of claim 1 wherein the base member includes a cavity for receiving the hollow body in the closed position.

3. The spout assembly of claim 2 wherein the base member includes first and second side walls extending at least to a top surface of the hollow body when the hollow body is in the closed position.

4. The spout assembly of claim 3 wherein the hollow body includes an overhang on the top surface.

5. The spout assembly of claim 1 wherein the hollow body includes an overhang on a top surface thereof.

6. The spout assembly of claim 1 wherein at least one of the hollow body or base member includes a first detent for engaging a first feature in the other of the hollow body or base member when the hollow body is in the closed position.

7. The spout assembly of claim 6 wherein at least one of the hollow body or base member includes a second detent for engaging a second feature in the other of the hollow body or base member when the hollow body is a first non-closed position, the passage and the predefined opening in the chamber in communication in the first non-closed position.

8. The spout assembly of claim 1 wherein at least one of the hollow body or base member includes a first detent for engaging a first feature in the other of the hollow body or base member when the hollow body is a first non-closed position, the passage and the predefined opening in the chamber in communication in the first non-closed position.

9. The spout assembly of claim 6 wherein the hollow body includes the first detent and the first feature comprises a recess in the base member.

10. The spout assembly of claim 1 further comprising an adhesive for securing the base member to the container.

11. The spout assembly of claim 1 wherein the base member further comprises a venting aperture defined therethrough, the venting aperture in venting communication with the internal chamber, and wherein the hollow body covers the venting aperture when in the closed position.

12. A spout assembly for use with a container having an internal chamber in communication with a predefined opening, the spout assembly comprising:
a base member configured to be secured to the container;
a hollow body defining a passage therethrough, the hollow body rotatably mounted to the base member to be movable between a non-closed position and a closed position, the passage and the predefined opening in the chamber being in communication in the non-closed position;
wherein at least one of the hollow body or base member includes a first detent for engaging a first feature in the other of the hollow body or base member when the hollow body is in the closed position and at least one of the hollow body or base member includes a second detent for engaging a second feature in the other of the hollow body or base member when the hollow body is the non-closed position.

13. The spout assembly of claim 12 wherein the first detent extends from a side surface of the hollow body.

14. The spout assembly of claim 13 wherein the base member includes the second detent.

15. The spout assembly of claim 12 wherein the base member includes the second detent

16. The spout assembly of claim 13 wherein the hollow body includes an additional detent disposed on an opposite side surface.

17. The spout assembly of claim 12 wherein the rotatably mounted hollow body defines an axis of rotation, and the first detent comprises a protrusion in the hollow body extending in the axial direction with respect to the axis of rotation.

18. The spout assembly of claim 17 wherein the first feature comprises a recess in the base member.

19. The spout assembly of claim 14 wherein the rotatably mounted hollow body defines an axis of rotation, and the second feature comprises a concavity in the hollow body defined in the radial direction with respect to the axis of rotation.

20. The spout assembly of claim 12 wherein the base member includes a cavity for receiving the hollow body in the closed position.

21. The spout assembly of claim 12 wherein the hollow body includes an overhang on a top surface thereof.

22. A container assembly comprising:
a container having an internal chamber and a surface in which is defined an opening;
a frangible sealing member affixed to the container to seal the defined opening;
a hollow body defining a passage therethrough, the hollow body rotatably mounted to the container to be movable between an open position and a closed position;
a puncture member formed with said hollow body, the puncture member configured to puncture the sealing member when the hollow body is moved from the closed position to the open position.

23. The container assembly of claim 22, wherein the container further comprises a base member, and wherein the hollow body is rotatably mounted to the base member.

24. The container assembly of claim 22, wherein the container includes a cavity for receiving the hollow body in the closed position.

25. The container assembly of claim 24 wherein the hollow body includes an overhang on the top surface.

26. The container assembly of claim 22 wherein the hollow body includes an overhang on a top surface thereof.

27. The container assembly of claim 22 wherein at least one of the hollow body or container includes a first detent for engaging a first feature in the other of the hollow body or container when the hollow body is in the closed position.

28. The container assembly of claim 27 wherein at least one of the hollow body or container includes a second detent for engaging a second feature in the other of the hollow body or container when the hollow body is a first non-closed position, the passage and the predefined opening in the chamber in communication in the first non-closed position.

29. The container assembly of claim 22 wherein at least one of the hollow body or container includes a first detent for engaging a first feature in the other of the hollow body or container when the hollow body is a first non-closed position, the passage and the predefined opening in the chamber in communication in the first non-closed position.

30. The container assembly of claim 27 wherein the hollow body includes the first detent and the first feature comprises a recess in the container.

31. The container assembly of claim 30 wherein the container further comprises a base member, the base member including the recess.
